(19) United States
(12) Patent Application Publication
(10) Pub. No.: US 2023/0196304 A1
(43) Pub. Date: Jun. 22, 2023

(54) NONVEHICLE BASED REPAIR AND MAINTENANCE IDENTIFICATION BY VEHICLE

(71) Applicant: Ford Global Technologies, LLC, Dearborn, MI (US)

(72) Inventors: Brendan Diamond, Grosse Pointe, MI (US); Andrew Denis Lewandowski, Sterling Heights, MI (US); Jordan Barrett, Milford, MI (US); Keith Weston, Canton, MI (US); Michael Alan Mcnees, Flat Rock, MI (US)

(73) Assignee: Ford Global Technologies, LLC, Dearborn, MI (US)

(21) Appl. No.: 17/554,847

(22) Filed: Dec. 17, 2021

(51) Int. Cl. G06Q 10/00

(52) U.S. Cl. CPC G06Q 10/20

(57) ABSTRACT

The disclosure is generally directed to systems and methods for nonvehicle based repair and maintenance identification by a vehicle including receiving, by the vehicle having one or more sensors including at least a camera, an image of a region of interest captured by the one or more sensors, identifying one or more maintenance and/or repair metrics associated with the region of interest, identifying a portion of the image associated with one or more maintenance and/or repair metrics, determining that a first metric of the one or more maintenance and repair metrics is exceeded by a feature included in the portion of the image, and transmitting data indicative of a location associated with the region of interest and the first metric, the region of interest requiring maintenance and/or repair associated with the metrics.

### FIELD OF THE DISCLOSURE

This disclosure generally relates to vehicles, and more particularly relates to systems and methods to identify non-vehicle repair and maintenance by a vehicle.

### BACKGROUND

Governments, homeowner's associations, landscaping companies, and others require ongoing surveillance of outdoor surroundings. Surroundings that require monitoring include lawns, trees, homes and the like to determine whether rules and regulations are being violated, whether locations are in need of attention, whether outdoor structures are in a state of disrepair, and whether locations are occupied inappropriately. Such monitoring and surveillance is typically done by hired personnel or by reporting by citizens or neighbors of an offending location. However, in everyday life, outdoor locations of concern, such as broken, degraded vegetation/trees, homes, and properties with long grass and bridges, overpasses or underpasses with structural cracks may be apparent or obvious and many could be a safety concern, wherein issues go unnoticed until a fine issues and/or a catastrophic occurrence. When issues are present and a fine or a citation is issued, controlling entities must either follow up or inspect repeatedly.

Typically, issues requiring monitoring largely go unaddressed until fines are imposed or a danger mandates action. Thus, it is desirable to provide solutions that address the need for identifying maintenance and repair issues efficiently.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example system that includes a vehicle in accordance with an embodiment of the disclosure.

FIG. 2 illustrates some example functional blocks that may be included in an on-board computer within a vehicle in accordance with an embodiment of the disclosure.

FIG. 3 illustrates a scenario for identification for maintenance and repair in accordance with an embodiment of the disclosure.

FIG. 4 illustrates a flow diagram of a method in accordance with an embodiment of the disclosure.

### DETAILED DESCRIPTION

### Overview

In terms of a general overview, this disclosure is generally directed to systems and methods for non-vehicle maintenance and repair identification including receiving at the vehicle having one or more sensors including at least a camera, an image of a region of interest captured by the one or more sensors, identifying one or more maintenance and/or repair metrics associated with the region of interest, identifying a portion of the image associated with one or more maintenance and/or repair metrics, determining a first metric of the one or more maintenance and repair metrics is exceeded by a feature included in the portion of the image, and transmitting data indicative of a location associated with the region of interest and the first metric, the region of interest requiring maintenance and/or repair associated with the metrics.

For example, embodiments herein apply to a vehicle driving in a neighborhood with sensors capable of capturing an image relevant to neighborhood restrictions and rules, such as height of grass or objects that are not permitted, may communicate the images including a violation to a home owner and/or to an infrastructure capable of disseminating the image to appropriate third parties.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternative implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

It should also be understood that the word “example” as used herein is intended to be non-exclusionary and non-limiting in nature. Furthermore, certain words and phrases that are used herein should be interpreted as referring to various objects and actions that are generally understood in various forms and equivalencies by persons of ordinary skill in the art. For example, the word “application” or the phrase “software application” as used herein with respect to a nomadic device such as a smartphone, refers to code (software code, typically) that is installed in the nomadic device. The code may be launched and operated via a human machine interface (HMI) such as a touchscreen. The word “action” may be used interchangeably with words such as “operation” and “maneuver” in the disclosure. The word “maneuvering” may be used interchangeably with the word “controlling” in some instances. The word “vehicle” as used in this disclosure can pertain to any one of various types of vehicles such as cars, vans, sports utility vehicles, trucks, electric vehicles, gasoline vehicles, hybrid vehicles, and autonomous vehicles. Phrases such as “automated vehicle,” “autonomous vehicle,” and “partially-autonomous vehicle” as used in this disclosure generally refer to a vehicle that can perform at least some operations without a driver being seated in the vehicle.

The Society of Automotive Engineers (SAE) defines six levels of driving automation ranging from Level 0 (fully manual) to Level 5 (fully autonomous). These levels have been adopted by the U.S. Department of Transportation. Level 0 (L0) vehicles are manually controlled vehicles having no driving related automation. Level 1 (L1) vehicles incorporate some features, such as cruise control, but a human driver retains control of most driving and maneuvering operations. Level 2 (L2) vehicles are partially automated with certain driving operations such as steering, braking, and lane control being controlled by a vehicle computer. The driver retains some level of control of the vehicle and may override certain operations executed by the vehicle computer. Level 3 (L3) vehicles provide conditional driving automation but are smarter in terms of having an ability to sense a driving environment and certain driving situations. Level 4 (L4) vehicles can operate in a self-driving mode and include features where the vehicle computer takes control during certain types of equipment events. The level of human intervention is very low. Level 5 (L5) vehicles are fully autonomous vehicles that do not involve human participation.

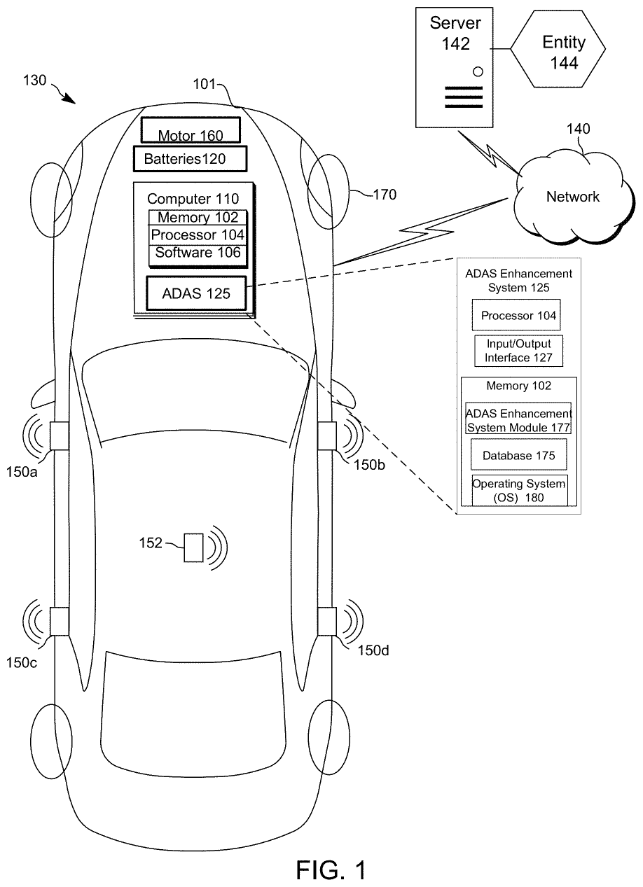

FIG. 1 illustrates an example system that includes a vehicle 130 which may be one of various types of vehicles such as a gasoline powered vehicle, an electric vehicle, a hybrid electric vehicle, or an autonomous vehicle, that may be configured as a Level 2 or higher automated or semi-automated vehicle. The system may be implemented in a variety of ways and can include various types of devices. For example, the example system can include some components that are a part of the vehicle 130, and, in some embodiments, other components that are accessible via a communications network 140. The components that can be a part of the vehicle 130 can include as chassis 101, computer 110 including memory 102, processor 104, software application 106, batteries 120, a motor 160, a propulsion system 170, which can include wheels or other method of propulsion. Software application 106, as further explained below, may implement features of the present disclosure such as collect images, process images and generate messages.

The vehicle computer 110 may perform various functions such as controlling engine operations (fuel injection, speed control, emissions control, braking, etc.), managing climate controls (air conditioning, heating etc.), activating airbags, and issuing warnings (check engine light, bulb failure, low tire pressure, vehicle in a blind spot, etc.). In one or more embodiments, vehicle computer 110 may enable a self-driving car or provide driver assistance. Thus, vehicle computer 110 may further include an Advanced Driver-Assistance System (“ADAS”) enhancement system 125. which is shown to further include, as one embodiment, the various components of the vehicle 130 that may be controlled, activated, and/or operated by the vehicle by the ADAS enhancement system 125. In one implementation, the ADAS enhancement system 125 can be an independent device (enclosed in an enclosure, for example). In another implementation, some or all components of the ADAS enhancement system 125 can be housed, merged, or can share functionality, with vehicle computer 110. For example, an integrated unit that combines the functionality of the ADAS enhancement system 125 can be operated by a single processor and a single memory device. In the illustrated example configuration, the ADAS enhancement system 125 includes the processor 104, an input/output interface 127, and memory 102, ADAS Enhancement System Module 177, database 175 and operating system 180. The input/output interface 127 is configured to provide communications between the ADAS enhancement system 125 and other components such as the sensors 150 the vehicle control components and any infotainment system, if present. The memory 102, which is one example of a non-transitory computer-readable medium, may be used to store an operating system (OS) 180, a database 175, and various code modules such as an ADAS enhancement system module 177. The modules, including ADAS enhancement system module 177, may be provided in the form of computer-executable instructions that can be executed by processor 104 for performing various operations in accordance with the disclosure.

In one or more embodiments, computer 110 enables memory 102 to store images and imaging data such as Lidar data and video, analyzes images locally or over network 140, and sends actions to be performed.

The vehicle on-board computer 110, in one or more embodiments, may be used to support features such as passive keyless operations, remotely-controlled or autonomous vehicle maneuvering operations, and remote vehicle monitoring operations. Vehicle computer 110, in one or more embodiments, may execute certain operations associated with autonomous vehicle maneuvering and/or remote vehicle monitoring, surveillance or the like in accordance with the disclosure. Additional functions performed by vehicle computer 110 may include collecting images and video, sensor data, analyzing the data against stored metrics and taking appropriate actions such as storing images/imaging data (Lidar)/video/etc. in memory 102, analyzing those images (local by computer 110 or a remote server 142 in communication with the vehicle 130 via the network 140), sending said images or portions of said images to server 142, sending actions to be performed to server 142, and executing on the actions, for example sending notice of violators directly from vehicle 130.

FIG. 1 further illustrates sensors 150a, 150b, 150c, 150d mounted upon or integrated within the vehicle 130 in a manner that allows the vehicle computer 110 to collect images via camera or Lidar or the like. Also shown is communication node 152 which enables vehicle 130 to communicate with network 140, server 142, which could be a cloud server or other infrastructure server, and entity 144, which could be a nearby vehicle, homeowner, or other third party. In one or more embodiments, sensors 150 collect data to be analyzed and/or data to be sent via communication node 152 to communication devices using WiFi, cellular, Bluetooth and the like via vehicle to infrastructure communication. Sensors 150a, 150b, 150c and 150d may include sensors and/or emitters capable of detecting objects, distances such as ultrasonic radar, LiDAR, cameras, and the like. In one or more embodiments, wireless communications nodes 152 may include one or more of Bluetooth®, or Bluetooth® low energy (BLE), or Ultra-Wideband (UWB) sensors and may include WiFi, cellular and other types of communication devices. Further, in one or more embodiments, wireless communication node data may be communicated via network 140 with cloud-based network data communicated to vehicle 130 via node 152. As shown, a single wireless communication node and/or sensor 152 may be mounted upon the roof of the vehicle 130 or, in other embodiments, a communication node may be within vehicle 130. The wireless communication system may use one or more of various wireless technologies such as Bluetooth®, Ultra-Wideband (UWB), Wi-Fi, ZigBee®, Li-Fi (light-based communication), audible communication, ultrasonic communication, near-field-communications (NFC), Bluetooth® low energy (BLE) and the like, for carrying out wireless communications with devices such as with a nearby vehicle, network 140 devices, server 142, and infrastructure entity 144 or the like. Server 142 may be in communication with vehicle 130 as a cloud as a subscription service or the like. Entity 144 may be in communication with vehicle 130 as an infrastructure entity, a homeowner's association, or a governmental entity.

The vehicle computer 110 may connect via communications network 140. The communications network 140 may include any one network, or a combination of networks, such as a local area network (LAN), a wide area network (WAN), a telephone network, a cellular network, a cable network, a wireless network, and/or private/public networks such as the Internet. For example, the communications network 140 may support communication technologies such as TCP/IP, Bluetooth®, cellular, near-field communication (NFC), Wi-Fi, Wi-Fi direct, Li-Fi, acoustic or ultrasonic audio communication, Ultra-Wideband (UWB), machine-to-machine communication, and/or man-to-machine communication.

In one or more embodiments, communications network 140 includes a cellular or Wi-Fi communication link enabling vehicle 130 to communicate with network 140, which may include a cloud-based network or source for transferring data in accordance with this disclosure. In one or more embodiments, network 140 connects the vehicle to an infrastructure, such as a governmental infrastructure, a homeowner association infrastructure or the like. In one or more embodiments, infrastructure entities, such as entity 144, may perform all or some of the methods, steps of the methods described herein including but not limited to performing analysis and taking action as described.

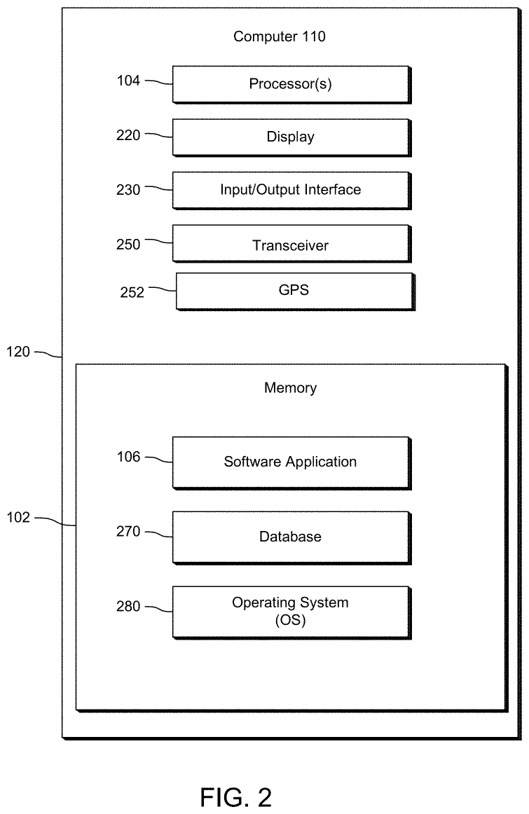

As shown in FIG. 2, a software application 106 may be provided in computer 110, which enables vehicle 130 to perform operations autonomously or semi-autonomously for performing remote-control operations such as, for example, taking images of the surroundings of vehicle 130, such as the yards, trees, overpasses, and for monitoring some actions performed autonomously by the vehicle 130. One example of an action performed autonomously or semi-autonomously by the vehicle 130 can be driving on a preset path through a neighborhood.

FIG. 2 illustrates some example functional blocks that may be included in computer 110 in accordance with an embodiment of the disclosure. The functional blocks of the computer 110 may include a memory 102, processor 104, display 220, an input/output (I/O) interface 230, transceiver 250, software application 106, database 270, and an operating system (OS) 280. The I/O interface 230, may include a touchscreen display 220 having softkeys (graphical icons). The operating system 280 can be any of various kinds of software such as, for example, an iOS® operating system, an Android® operating system, or a Windows® operating system.

The software application 106 may be a software application that is downloaded into the computer 110 from an app store. The software application may be used to carry out various operations such as performing surveillance of regions of interest to identify locations and the like.

The transceiver 250 can include a wireless transmitter and/or a wireless receiver that is used to communicate outside vehicle 130 to infrastructure, other vehicles, servers or the like. The communications may be carried out by using any of various wireless formats such as, for example, Bluetooth®, Ultra-Wideband (UWB), Wi-Fi, ZigBee®, Li-Fi (light-based communication), audible communication, and ultrasonic communication. The transceiver 250 may be coupled to various components in the vehicle 130, such as, for example, a system for in-vehicle communications (displaying messages, providing warnings, etc.) and in some embodiments also be coupled to communication node 152 for communications with other vehicles, infrastructure, remote server 142, V2X communications, etc., and/or to the sensors 150a, 150b, 150c, 150d and 150e for detecting regions of interest outside vehicle 130.

As one of ordinary skill in the art will appreciate with the benefit of the present disclosure, a file sent wirelessly may be a compressed data file or other type of data formation appropriate for different wireless protocols used for transmission as necessary for system requirements. As used herein, the term “file” includes without limitation a series of data packets capable of forming a mapping of obstructions.

The computer 110 in vehicle 130 may be configured to operate in cooperation with the software application 106 to execute various operations for identifying repair and maintenance required actions in a region of interest in accordance with the disclosure. More particularly, a system in accordance with one or more embodiments may include a memory that stores a memory 102 within a vehicle 130 that stores computer-executable instructions, a processor 104 configured to access the memory 102 and execute the computer-executable instructions to: receive at vehicle 130 having one or more sensors 150 including at least a camera, an image of a region of interest captures by the one or more sensors 150; identify one or more maintenance and/or repair metrics associated with the region of interest, identify a portion of the image associated with the one or more maintenance and/or repair metrics; determine a first metric of the one or more maintenance and repair metrics is exceeded by a feature included in the portion of the image; and transmit data indicative of a location associated with the region of interest and the first metric, the region of interest requiring maintenance and/or repair associated with the metrics. The system further includes a transmitter, such as transceiver 250 coupled to the processor 104, the transmitter configured to transmit data identifying the location to a third party, such as a regulatory authority, a home owner's association or a lawn maintenance company, the location requiring maintenance and/or repair.

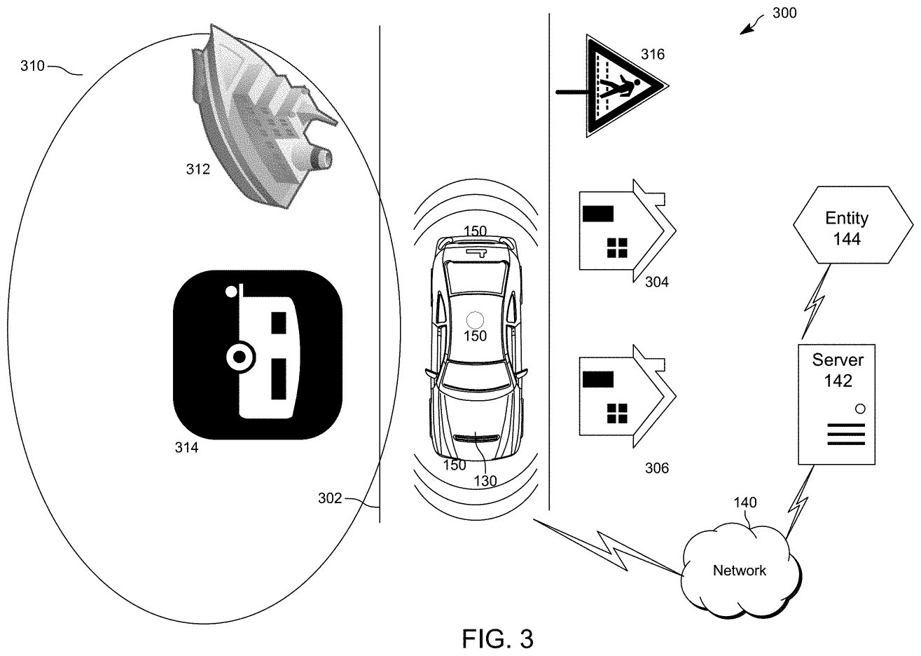

FIG. 3 illustrates a scenario involving vehicle 130 for non-vehicle based repair and maintenance identification using information provided from the existing vehicle sensors 150 which can include cameras, LIDAR, RADAR, ultrasonic sensors in combination with image recognition to improve safety and increasing property value. In one or more embodiments, images captured by the vehicle 130 of a region of interest, such as neighborhood 300, can include images along street 302, such as homes 304, 306 or include a geofenced area 310 wherein vehicle 130 is searching for items subject to regulation, such as boats 312 and trailers 314. Vehicle 130 may also identify signage 316 to ensure proper visibility for safety purposes.

Additionally, geofenced area 310 may include locations associated with one or more maintenance and/or repair metrics. Maintenance and repair metrics can include grass length, tree leaf coverage, tree color, road condition and roughness as estimated through vehicle accelerometers, among other things aw will be appreciated by one of skill in the art with the benefit of the present disclosure. In one or more embodiments, organizations can set thresholds and “features of concern” for each predefined region of interest for vehicle 130.

For example, if a maintenance metric were height of grass, and a length is identified as, for example, four inches as being a metric for a neighborhood threshold of a homeowners association, the image can estimate the length of grass using computer vision techniques, such as photogrammetry techniques and algorithms. For example, as one of ordinary skill in the art with the benefit of this disclosure will appreciate, algorithms may be applied to take 2D images from a vehicle and create three dimensional images so as to allow determination of grass height when coupled with range data from a source such as LiDAR. More specifically, a vehicle with appropriate cameras and such may take a series of overlapping photos yielding photos of a same object from a variety of different angles. Next, a photogrammetry algorithm/technique could then isolate points identified between two or more photos and with other information from the images such as camera angle, the focal length of the camera and begin to establish a three dimensional geometric model. Thus, using photogrammetry techniques, a transformation model from two dimensions to three dimensions may be constructed yielding an (X,Y,Z) coordinate position.

Further, as one of skill in the art will appreciate, LiDAR can also be used to determine grass height. The emitted beam from a LiDAR unit may measure the distance to the lawn as the time interval between emitted and reflected pulses. The difference when multiplied by the speed of light will yield the distance. The angle of the LiDAR unit is known from the installation of the unit. Thus, simple trigonometric equations determine the height of the grass in question.

In one or more embodiments, an initial determination of grass height can be made upon vehicle deployment to the neighborhood and subsequent image captures can provide follow-up details on violations of minimum lawn grass height. Such initial determinations may be stored as data via software application 106 within database 270.

If the determined height of grass exceeds four inches, the location of the image showing the excessive grass height is recorded in database 270. Other images within the region of interest can include, for example, a landscape metric, an ambience metric associated with color, state of repair, predetermined features, a structural condition, a bridge or roadway condition, and/or a metric related to a presence of a utility vehicle, trailer, truck, boat or recreational vehicle.

Thus, trees that are in dead, have broken limbs, wrong coloration, degradation, overgrown, in need of trimming or removal and the like, can be identified in an image or portion of an image and designated so that action can be taken. If vehicle 130 is equipped with appropriate sensors, images or data collected when driving near or underneath a bridge or overpass may include other items such as cracks in structural foundation or bridges can be recorded, and more locations of said bridges and overpasses can be identified.

After vehicle 130 records any violations, for example, a metric associated with the region of interest (e.g., grass exceed height threshold, limb sticks out beyond distance threshold into street, etc.) is exceeded, a location and/or at least a portion of an image may be transmitted by vehicle 130 via transceiver 250. The location data may be obtained from a GPS or other position device or system associated with vehicle 130, including motion sensors and gyroscopes. This information, along with a time stamp and vehicle or account identification may be transmitted with the image data, such as in the form of metadata.

In one or more embodiments, the transmission may be to a third party entity, such as server 142 and entity 144, which can include organizations that can set thresholds, or features of concern that identify metrics for vehicle 130 to identify within a region of interest. For example, if a region of interest includes areas where bridges or overpasses exist, an entity 144, such as a governmental entity, municipality or the like can identify metrics such as a size of a crack in a structural foundation of any identified bridges. Thus, images of cracks in a bridge will be scanned or captured and a size may be measured at vehicle 130 to determine if a metric is within the preset threshold. Vehicle 130 may then record the location of the issue, document findings using a database or cloud networking. As shown in FIG. 3, vehicle 130 may be connected to network 140 which may be connected to a third party, such as a municipality or homeowner's association.

In one or more embodiments, the data concerning any images that identify a metric outside a preset threshold are communicated to a respective authority or property owner to enable next steps. For example, after vehicle 130 transmits data identifying a location flagged as outside a threshold, next steps can include an investigation or an assessment to enable a repair, notification, citation, or the like. For example, as shown in FIG. 3, a boat 312 and a trailer 314 may be present and listed as prohibited items for neighborhood 300. A preset threshold can be that zero boats are allowed in the geofenced area 310, or the threshold can be a number of days, hours or weeks that the prohibited items are present. Identified locations within a region of interest in an image can include features that do not need repair, and transmitting data over network 140 may include informing other vehicles or an infrastructure that violations do not exist or have been remedied.

In one or more embodiments, vehicle 130 may further receive instructions to scan a region of interest to validate that a repair or maintenance metric is no longer outside of a preset threshold. For example, if a deadline or resolution is provided by regulating authorities, vehicle 130 can operate to scan the region of interest at the location where a prior violation or metric threshold was exceeded and validate that the metric is no longer outside the preset threshold or confirm that, at a later date, the preset threshold was still outside the preset threshold.

Thus, for example, if an owner of a house must cut the grass within 5 days or a fine and/or landscaping crew will be sent to the property, vehicle 130 may be deployed, either autonomously or semi-autonomously, or a personal vehicle of a neighbor may drive by the property, after the 5 days and scan the location of the house. In one or more embodiments, if vehicle 130 determines it has identified an issue a second time (or identified by another vehicle previously), then vehicle 130 may transmits data to server 142 for processing the (1) data including an action needed and/or (2) one or more images or a portion of an image and data identifying the geographic location associated with the image(s) using network 140. In one or more embodiments, the data may include an instruction to remedy the violation, such as sending instructions to an autonomous lawn mower, contacting a landscaper or the like. For example, if automated systems are in place, vehicle 130 may transmit data to trigger automated systems or services if a metric is outside a preset threshold.

Alternatively, vehicle 130 can transmit data to a homeowner's association and/or the home owner to allow for the collection of bids for a service. Thus, vehicle 130 may be used for non-governmental, advertising, or private inspection type services.

In other embodiments, images can include identifiable features such as boats, recreational vehicles, trailers, pickup trucks and the like that have a limited number days allowed in a designated region of interest may be part of a warning system. For example, an image containing a trailer that requires removal can be transmitted to an infrastructure that in turn sends a message to a property owner that the trailer will be in violation in a matter of hours or days. Such a warning can potentially save the property owner unwanted fines and benefit the neighborhood from increased property values by keeping a neighborhood aesthetically pleasing.

Additionally, neighborhood homeowner's association imaging performed by vehicle 130 may also be include lighting, lamp posts, dusk-to-dawn sensors outages, sidewalk damage, and broken or missing signage. For example, a sign that indicates “deaf child” that is taken out by a storm could pose a significant danger, and transmission of data associated with high likelihood of injury could include additional highlighting since such locations could pose a danger to vehicles and children. Thus, such reporting may be directly sent to a homeowner's association, a municipality, and directly to homeowners or other interested parties.

In one or more embodiments, the present threshold may include metrics regarding blight in a municipality wherein the region of interest is a predefined area of a municipality such that identified locations include areas in the municipality with gutters or siding falling off, roof damage, and/or homes sporting an unacceptable color, the presence of recreational vehicles, abandoned vehicles, or damaged sidewalks and roads, and the like. For example, referring to FIG. 3, homes 304 and 306 could have gutters or siding falling off or have an unacceptable color.

In one or more embodiments, vehicle 130 may be configured to transmit data over network 140 to server 142 or to a cloud concerning a metric outside a preset threshold that instigates an escalation of a preexisting violation to a fine or third party company that completes a repair/maintenance. For example, transmitting data over network 140 to server 142, which may include transmitting to a third party entity 144, which may be a head of a regulatory or municipality authority to enable issuing of fines, setting of deadline for action upon detection of metric being exceeded, and subsequent validation. In one or more embodiments, entity 144 may include an autonomous vehicle or other equipment that repairs, or arranges for maintenance such as tree trimming (cutting branches that extend over into the road or too low).

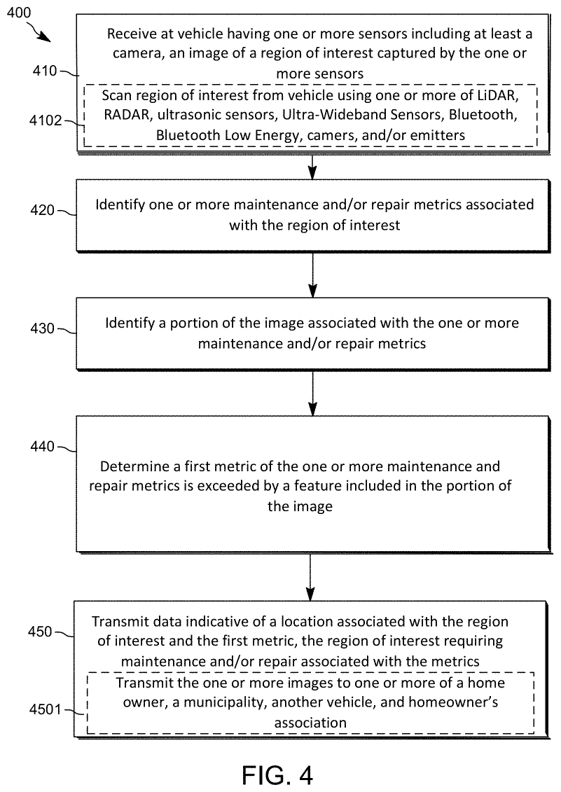

Referring to FIG. 4, in accordance with the disclosure, a flow diagram illustrates a method in accordance with an embodiment of the disclosure. As shown, block 410 provides for receiving at the vehicle having one or more sensors including at least a camera, an image of a region of interest captured by the one or more sensors. For example, vehicle 130 including sensors 150 takes images and provides the images to computer 110.

Block 410 includes optional block 4102 in dashed lines, which provides for scanning the region of interest from the vehicle using one or more LiDAR, RADAR, ultrasonic sensors, and Ultra-Wideband (UWB) sensors, one or more cameras, one or more emitters. For example, as shown in FIG. 1, vehicle 130 includes sensors 150a-e disposed on and about vehicle 130 to collect image data and the like.

In one or more embodiments, the receiving the one or more images further includes receiving a file containing data identifying one or more locations within the region of interest requiring additional one or more images, the file identifying prior violations outside of the acceptable range of maintenance and repair metrics. For example, the additional one or more images may be updates to verify that issues regarding repair or maintenance have been taken rectified.

In one or more embodiments the receiving the one or more images includes receiving the images from a cloud-based network. For example, if cameras are cloud based they can be transmitted to transceiver at vehicle 130.

Block 420 provides for identifying one or more maintenance and/or repair metrics associated with the region of interest. For example, within computer 110 or available over network 140, a database of maintenance and repair metrics can be stored. The one or more maintenance and/or repair metrics can include a grass height, the acceptable metric based on one or more of a homeowners association provided metric or a predetermined metric, a landscape metric, an ambience metric associated with color, state of repair, and predetermined features, a structural condition, a bridge or roadway condition, or a metric related to a presence of a utility vehicle, trailer, truck, boat or recreational vehicle.

Block 430 provides for identifying a portion of the image associated with one or more maintenance and/or repair metrics. For example, if a region of interest is a neighborhood or municipality, the image may include metadata or, using image recognition software, the image may identify repair or maintenance features.

Block 440 provides for determining a first metric of the one or more maintenance and repair metrics is exceeded by a feature included in the portion of the image. For example, if image recognition software identifies images with grass present, an acceptable range, or preset threshold for maintenance and repair may be used to detect that a metric for grass length is exceeded.

Block 450 provides for transmitting data indicative of a location associated with the region of interest and the first metric, the region of interest requiring maintenance and/or repair associated with the metrics. For example, if block 440 results in an image that identifies grass beyond a threshold acceptable range, computer 110 can transmit over network 140 to server 142 or to entity 144, data identifying the location. The entity 144 could include another vehicle, a homeowner, a homeowner's association, a municipality, a lawn service company or the like. In one or more embodiments, entity 144 may include an autonomous machine for performing further tasks, for example. In one embodiment, the entity 144 is a reporting entity or regulating authority, the transmitting enables a governmental citation regarding the maintenance and/or repair. Within block 450, block 4501 provides for transmitting the image to one or more of a home owner, a municipality, another vehicle and a homeowner's association.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” “example implementation,” etc., indicate that the embodiment or implementation described may include a particular feature, structure, or characteristic, but every embodiment or implementation may not necessarily include the particular feature, structure, or characteristic. Moreover, such phrases are not necessarily referring to the same embodiment or implementation. Further, when a particular feature, structure, or characteristic is described in connection with an embodiment or implementation, one skilled in the art will recognize such feature, structure, or characteristic in connection with other embodiments or implementations whether or not explicitly described. For example, various features, aspects, and actions described above with respect to an autonomous parking maneuver are applicable to various other autonomous maneuvers and must be interpreted accordingly.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, nomadic devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method for a vehicle comprising:
receiving, by the vehicle having one or more sensors including at least a camera, an image of a region of interest captured by the one or more sensors;
identifying one or more maintenance and/or repair metrics associated with the region of interest;
identifying a portion of the image associated with one or more maintenance and/or repair metrics;
determining that a first metric of the one or more maintenance and repair metrics is exceeded by a feature included in the portion of the image; and
transmitting data indicative of a location associated with the region of interest and the first metric, the region of interest requiring maintenance and/or repair associated with the metrics.

2. The method of claim 1, wherein the transmitting data includes transmitting a date and time associated with the image of the region of interest.

3. The method of claim 2 wherein the transmitting data includes transmitting to one or more of a home owner's association, a property owner, a vehicle, an authority or autonomous machine.

4. The method of claim 1 wherein transmitting includes transmitting to a governmental entity responsible for citations regarding the maintenance and/or repair.

5. The method of claim 1 wherein the one or more maintenance and/or repair metrics include one or more of:
a grass height, the acceptable metric based on one or more of a homeowners association provided metric or a predetermined metric;
a landscape metric;
an ambience metric associated with color, state of repair, and predetermined features;
a structural condition;
a bridge or roadway condition; and
a metric related to a presence of a utility vehicle, trailer, truck, boat and/or recreational vehicle.

6. The method of claim 1, wherein the receiving the image includes:
scanning the region of interest from the vehicle using one or more LiDAR, RADAR, ultrasonic sensors, Ultra-Wideband (UWB) sensors, one or more cameras, and one or more emitters.

7. The method of claim 1 wherein the determining the first metric of the one or more maintenance and repair metrics is exceeded by the feature included in the portion of the image further comprises:
receiving a file containing data identifying one or more locations within the region of interest requiring one or more images, the file identifying prior violations outside of the acceptable range of maintenance and repair metrics.

8. The method of claim 1 wherein the transmitting data includes transmitting the one or more images to one or more of a home owner, a municipality, another vehicle, and homeowner's association.

9. A system comprising:
a memory that stores computer-executable instructions; and
a processor configured to access the memory and execute the computer-executable instructions to:
receive an image of a region of interest associated with a neighborhood;
identify one or more maintenance and/or repair metrics associated with the region of interest;
identify a portion of the image t associated with one or more maintenance and/or repair metrics;
determine that a first metric of the one or more maintenance and/or repair metrics is exceeded by a feature within the portion of the image; and
a transmitter coupled to the processor, the transmitter configured to transmit data indicative of a location associated with the region of interest and the first metric to a third party entity.

10. The system of claim 9, wherein the transmitter further transmits data identifying the location and the first metric including a time allocated for maintenance and repair and an identification of a service provider.

11. The system of claim 9 wherein the third party entity is one or more of a home owner, a municipality, another vehicle, and homeowner's association.

12. The system of claim 9 wherein the third party entity is a reporting entity or regulating authority responsible for issuing a citation regarding the maintenance and/or repair.

13. The system of claim 9 wherein the one or more maintenance and/or repair metrics include one or more of:
a grass height, the acceptable metric based on one or more of a homeowners association provided metric or a predetermined metric;
a landscape metric;
an ambience metric associated with color, state of repair, and predetermined features;
a structural defect;
a metric related to a presence of a utility vehicle, trailer, truck, boat or recreational vehicle; and
a roadway defect.

14. The system of claim 9 the image is identified via a scan of the region of interest from the vehicle using one or more LiDAR, RADAR, ultrasonic sensors, and Ultra-Wideband (UWB) sensors, Bluetooth®, Bluetooth® Low Energy (BLE), one or more cameras, one or more emitters.

15. The system of claim 9 wherein the transmitter is configured to transmit data indicative of the location via a cloud-based network to a subscription service associated with the third party if the first metric is outside a preset threshold.

16. The system of claim 9 further comprising:
a receiver coupled to the processor, the receiver configured to receive a file containing data identifying a geofencing boundary, the geofencing boundary enabling the system to receive the image of the region of interest associated with the neighborhood.

17. A vehicle comprising:
a chassis;
a motor coupled to the chassis;
a propulsion system coupled to the motor;
one or more sensors coupled to the chassis, the one or more sensors including at least a camera,
an on-board computer coupled to the chassis, the on-board computer including a memory and a processor coupled to the memory, the processor configured to execute one or more instructions to:
receive an image of a region of interest captured by the one or more sensors;
identify one or more maintenance and/or repair metrics associated with the region of interest;
identify a portion of the image t associated with one or more maintenance and/or repair metrics;
determine a first metric of the one or more maintenance and repair metrics is exceeded by a feature included in the portion of the image; and
transmit data indicative of a location associated with the region of interest and the first metric, the region of interest requiring maintenance and/or repair associated with the metrics.

18. The vehicle of claim 17 wherein the vehicle is autonomous or semi-autonomous.

19. The vehicle of claim 17 wherein the one or more maintenance and/or repair metrics associated with the region of interest include one or more of:
a grass height, the acceptable metric based on one or more of a homeowners association provided metric or a predetermined metric;
a landscape metric;
an ambience metric associated with color, state of repair, and predetermined features;
a structural condition;
a bridge or roadway condition; and
a metric related to a presence of a utility vehicle, trailer, truck, boat or recreational vehicle.

20. The vehicle of claim 17 wherein the third party entity is a reporting entity or regulating authority responsible for issuing a citation to issue regarding the maintenance and/or repair.
